(19) United States
(12) Patent Application Publication
(10) Pub. No.: US 2005/0159913 A1
(43) Pub. Date: Jul. 21, 2005

(54) Read-write processing device for RFID tag

(76) Inventors: Tomonori Ariyoshi, Ayabe (JP); Koyo Ozaki, Ayabe (JP)

Correspondence Address: BEYER WEAVER & THOMAS LLP, P.O. BOX 70250, OAKLAND, CA, 94612-0250, US

(21) Appl. No.: 11/039,639

(22) Filed: Jan. 19, 2005

(30) Foreign Application Priority Data
Jan. 20, 2004 (JP) 2004-012249
Jan. 13, 2005 (JP) 2005-005865

(51) Int. Cl. G01M 19/00

(52) U.S. Cl. 702/122; 340/10.1; 324/500

(57) ABSTRACT

A read-write processing device communicates with an RFID tag provided with a semiconductor memory to carry out read and write processes. A communication processing device executes communication processes with the RFID tag, exchanging commands and responses, and a data creating device creates safety data indicative of a margin of safety of communication based on communication results by the communication processing device. The created safety data are displayed or outputted to the outside by an output device.

Priority is claimed on Japanese Patent Applications 2004-012249 filed Jan. 20, 2004 and 2005-005865 filed Jan. 13, 2005.

### BACKGROUND OF THE INVENTION

This invention relates to a read-write processing device for carrying out non-contact communications with an RFID tag containing a semiconductor memory to read out or write data from or into this memory.

Systems having a memory medium storing various data attached to each article to be transported and being adapted to read and write data from and into this memory medium by wireless communications are coming to be introduced into control sites of cargoes and assembly lines of factories. Such a system is referred to as an RFID (radio frequency identification) system and the aforementioned memory medium to be attached to each article to be transported contains an IC chip containing a semiconductor memory and a communication antenna coil and is commonly referred to as an RFID tag or a non-contact IC tag. In what follows, it will be referred to as an RFID tag, or simply as a tag.

Prior art read-write processing devices for an RFID system are structured either as a reader-writer having both an antenna part and a control unit inside a same housing structure or as a controller separate from an antenna part. Both when reading and writing data, prior art read-write processing devices are adapted to transmit a command of a specified format to an RFID tag and to receive from the RFID tag a response to this command. When an RFID tag without containing an inner power source is used, an induced electromotive force is generated in the antenna coil on the side of the RFID tag by means of transmission waves from the antenna part such that a control circuit inside the RFID tag will be driven.

With an RFID system as described above, there is a high probability that various kinds of noise will come to be mixed in the communication region for the tag and the antenna part so as to cause communication errors since the system is often introduced in an environment where machines and apparatus of various types are installed. For this and to thereby adjust the distance between the tag and the antenna part such that there will be no error in actual communications with the RFID tags.

In view of the above, the present applicant has earlier proposed a read-write processing device provided with a test mode in which a read-write process is carried out while the distance to the tag is adjusted and a display light is switched on if a communication error occurs. (See Japanese Patent Koho 2,610,897).

According to the disclosure in aforementioned Japanese Patent Koho 2,610,897, only the occurrence of a communication error is checked. Although a communication may have been successful, no judgment is made as to the margin of safety with which the communication was carried out. In an environment where an RFID system is set, it is highly probable that the level of noise may change significantly by a sudden occurrence of a noise or an increase of the noise level because new machines have been introduced. Thus, if the tag is in a condition of a small margin of safety such as if the tag is set near the boundary of the communication region of the antenna part or if the noise is in an unusually elevated condition, a communication error is likely to occur even by a small increase in the noise level.

In view of the variations in noise, prior art RFID systems are adapted to repeat a same communication process for a plurality of times with same contents. Even with a control of this type, however, all communications may still fail if a condition with large noise persists. It is therefore preferable to include a sufficient margin of safety when the distance between the RFID tag and the antenna part is set such that communications can be carried out even if a fairly high level of noise is generated.

With prior art RFID systems, furthermore, it was commonly done to carry out a communication after the tag is once stopped in front of the antenna part. In recent years, however, factory assembly lines are being required to shorten the repetition times in order to reduce the production cost, For this reason, there are increased situations where communication processes are carried out without stopping the tags.

If a communication is to be carried out while the RFID tag is continuously moving, it is necessary to complete the communication while the tag is within the communication region of the antenna part. For this purpose, it is desirable to adjust such that the time required for the tag to pass through the communication region will be sufficiently longer than the time required for the communication with the tag. It is also desirable to make the adjustment such that the communication can be repeated for a plural number of times in view of the noise for communicating with the tag in motion.

The time required for each communication becomes longer as the volume of data to be transmitted and received increases. In the case of communication with a moving tag, the number of communications that can be carried out decreases as the volume of data increases especially since the communications must be completed while the tag remains within the communication region. It is therefore even more important in the case of a communication with a moving tag to carry out the communications with a sufficient margin of safety.

### SUMMARY OF THE INVENTION

The present invention was accomplished in view of the problem as described above and its object is to make adjustments on the conditions of communication between the antenna part and the RFID tag prior to actual measurements such that communications will be possible under a stable condition even if there are changes in the noise level.

An important example of the conditions of communication is the distance between the antenna part and the tag. In the case of a communication while the tag is in motion, other important examples of the condition of communication include the speed of motion of the tag and the data volume.

What is herein referred to as the margin of safety for communication under a condition wherein communication with a tag is possible may be regarded as an indicator showing the level of noise against which this condition can withstand. The larger the safety margin, the stronger is the condition against the variations in noise such that a communication process with the RFID tag can be carried out stably. The stability margin changes, however, depending upon the distance between the RFID tag and the antenna part. In the case of a communication with a moving tag, the safety margin also changes depending upon the speed of motion of the tag, as well as the volume of the data.

This invention relates to a read-write processing device for communicating with an RFID tag provided with a semiconductor memory to carry out read and write processes with this semiconductor memory, preferably being provided with a control part comprising a computer. Such a read-write processing device may be formed as a reader-writer provided with an antenna part (inclusive of an antenna coil and a circuit for transmission and reception of signals) for communication with the RFID tag but may also be formed as a controller separated from such an antenna part. Alternatively, it may also be formed as a controller inclusive of the transmitter circuit and the receiver circuit of the antenna part.

A first read-write processing device according to this invention may be described as comprising a communication processing device that executes communication processes with the RFID tag, a data creating device that creates safety data indicative of a margin of safety of communication based on communication results by the communication processing device, and an output device that displays or outputs to the outside the safety data created by the data creating device. The communication processing device, the data creating device and the output device thus described are also included in the second through seventh read-write processing devices of this invention to be described below.

In the description of the first read-write processing device of this invention given above, the communication processing device and the data creating device may be formed by installing corresponding programs into a computer that forms the aforementioned control part. The communication processing device is preferably adapted to transmit either a read command or a write command to the RFID tag through the antenna part and to recognize the content of the response received by the antenna part. The aforementioned communication processes may include at least transmission of one command and the reception of response to this command and may also include the transmission of a command for identifying the kind and memory structure of the RFID tag (referred to as the system read). In what follows, the transmission of this system read and the reception of its response are referred to as the preliminary communication.

The data creating device is adapted to judge whether a normal response has been obtained to the transmission of the command for each of communication processes while the communication processes are being carried out by the communication processing device and to create data indicative of a margin of safety in the communication based on the history of the results of such judgments. Examples of data indicative of a margin of communication safety include the number of times of successful (or failed) communication, ratio of successful (or failed) communication, numbers converted into frequencies and percentages and symbols indicative of one of the levels into which the safety margin is divided (such as 1, 2, 3, A, B and C). When the communication is carried out while the tag is in motion, the data volume that can be transmitted or the number of times communication can be made with the tag while the tag is passing through the communication region may be treated as data indicative of a safety margin. Although it is preferable to always transmit commands with the same content in the plurality of times of communication processes in which judgments are made by the data creating device, it is not a requirement and the content of the command may be changed at a specified point in time.

If the output device is formed as a means for displaying the margin of communication safety, it may show numerical values by substituting them by an analog display such as a graph in addition to showing numbers and characters themselves. When data indicative of a level are displayed, a display light may be provided for each level such that a corresponding one of the lights can be switched on or off or one display light may be used to change its color according to the level to be indicated. Such an output device may be set on the surface of a housing structure serving as the main body of the read-write processing device.

When the output device is formed as a means for outputting the data indicative of the safety margin to the outside, such means may be realized by an output interface to a host apparatus such as a personal computer or a programmable logic controller (PLC). The output may be made either as a digital signal or as an analog signal.

With a read-write processing device thus structured, data indicative of a margin of safety of communication while communication process is carried out for a plural number of times can be reported either in the form of a display or an output, such that the user can easily understand the level of the margin of safety.

In a second read-write processing device according to this invention, the data creating device counts the number of times of success or failure in communication while the communication processing device executes a plural number of times of the communication processes and obtains the margin of safety based on the counted number of times.

In this counting process by the data creating device, it is preferable to judge for each communication process whether a normal response has been obtained for a transmitted command and to count the number of successes or failures according to the result of this judgment. In this case, at the point in time when the communication process has been carried out for a predetermined number of times, a ratio or difference may be obtained for the number counted thus far with respect to this predetermined number. A number indicative of the degree of success or failure in the communication may be thus obtained as a margin of communication safety.

With a second read-write processing device thus characterized, a degree of success or failure in communication while the communication process is repeated for a plural number of times is reported in the form of a display or an output. Thus, the user can learn about the margin of communication safety. If the degree of success is reported, the margin of safety may be considered large if the reported degree of success is high. If the degree of failure is reported, on the other hand, the margin of safety may be considered small if the reported degree of failure is high.

A third read-write processing device according to this invention is characterized as comprising not only a communication processing device, a data creating device and an output device as described above but also a level adjusting device that adjusts the transmission level of transmission signal transmitted to the RFID tag, a control device that controls operations of the communication processing device while adjusting the transmission level by means of the level adjusting device, and a judging device that judges whether or not communication with the RFID tag can be carried out properly based upon results of processing by the communication processing device. After the control device causes the communication processing device to start communication with the RFID tag under a condition where the level of the transmission signal is set at a certain value, it changes the level of the transmission signal to a lower value than the current value while causing the communication to be repeatedly executed as the judging device judges that communication can be carried out properly. The data creating device creates the safety data based on the level of the transmission signal at the point in time when the judging device judges that communication cannot be carried out properly or the number of times the level of the transmission signal has been changed up to this point in time.

In the above, it is preferable to provide the level adjusting device incorporated in the antenna part as a circuit for changing the Q value of the antenna coil. The level of the transmission signal can be changed, for example, by structuring the level adjusting device with a plurality of resistors and switching circuits for switching the connections of these resistors on and off and by varying the magnitude of the resistance value for the antenna part.

The control device and the judging device may be provided by installing a program in a computer that forms a control part. The control device may be adapted to control such that the aforementioned communication process is carried out at least once under a condition where the level of the transmission signal is set to a certain value but it may be adapted to carry it out for a plural number of times, like the second read-write processing device described above. The control device may be adapted to cause the communication processing device to stop the communication process at the point in time where the judging device judges that communication cannot be carried out properly.

If the distance between the RFID tag and the antenna part is constant, power that can be supplied to the RFID tag becomes smaller as the level of the transmission signal becomes lower. As a result, it may be predicted that the level of the response signal from the RFID tag becomes lower and the possibility of failure in the communication process becomes higher. Thus, if the level of the transmission signal used for an ordinary read-write process (hereinafter referred to as the ordinary transmission level) is set as the initial value and a communication process is carried by decreasing the transmission level in a stepwise fashion, it may be concluded that the margin of communication safety becomes larger as the difference between the transmission level when the communication process fails and the ordinary transmission level is made smaller.

Based on this idea, the control device may be adapted to carry out communication processes by reducing the level of the transmission signal in a stepwise fashion from a specified initial value. In this process of changing the level of the transmission signal, the level may be lowered by a fixed amount but the invention is not limited by this choice. There may be some fluctuations in the amount by which the level is changed each time. This is also true in the case of the fourth read-write processing device of this invention to be described below.

The judging device may be adapted to judge that communication can be carried out properly if a correct response is obtained to a command.

Regarding the margin or communication safety at a point in time when it is judged that communication cannot be carried out properly, the data creating device may be adapted to determine either the situation belongs at least to a pass-level or a failure level and to treat this determined level as the data indicative of the margin of communication safety. Such a determination between a pass-level and a failure level may be made by comparing the transmission level as of the time when it was determined that communication cannot be carried out properly with a specified threshold value. It will be determined to be the pass-level if the transmission level is above this threshold value and the failure-level if the transmission level is below the threshold value.

When a third read-write processing device counts the number of times the level of the transmission signal has been changed, it is possible to use the method of comparing the counted value at the time of communication failure with a specified threshold value. By this method, it is determined to be in the pass-level if this counted value is above the threshold value.

When this number of times the level of the transmission signal has been changed is counted, a product obtained by multiplying this counted number by a specified point number may be set as the data indicative of the margin of communication safety. If the level change of the transmission signal can be carried out up to a maximum of five times, for example and 10 points are to be assigned for each change, the margin of communication safety can be expressed by a point number compared with the full score of 50 points.

When the data indicative of the margin of communication safety are to be shown in terms of the pass-level and the failure-level, the output device may be adapted to display the data by means of a plurality of lights of a display light of a multi-color type.

When such data are to be outputted, the result of the judgment may be outputted as a digital signal, defining “1” as indicating the pass-level and “0” as indicating the failure-level, for example. Such an output is preferably made to a host apparatus such as a personal computer or a PLC, as was the case with the first read-write processing device.

When such data are expressed by a point number, a displayer capable of point number display such as an LED displayer with 7 segments and a liquid crystal panel may be used as the output device. In this case, too, a digital signal indicative of a point number may be outputted to a host apparatus.

A fourth read-write processing device according to this invention is characterized as comprising not only a communication processing device, a data creating device and an output device as described above but also a level adjusting device that adjusts the transmission level of transmission signal transmitted to the RFID tag, and a control device that controls operations of the communication processing device while adjusting the transmission level by means of the level adjusting device. The control device of this fourth read-write processing device is adapted to cause the communication processing device to execute a communication process with two or more specified number of cycles and to change the level of the transmission signal to a lower value than the current value every time one cycle of the communication process is finished. The data creating device is adapted to create the safety data based on the cycle of communication process until which communication was carried out properly or the smallest value of the level of the transmission signal when communication was carried out properly.

The level adjusting device of the fourth read-write processing device may be similar to that of the third read-write processing device. The control device, too, may be similar to that of the third read-write processing device although the details of their controls are somewhat different. Thus, it can also be set by installing a necessary program to a computer that comprises the control part.

The third read-write processing device was adapted to lower the next transmission level if communication is carried out properly and to determine the margin of communication safety at the point in time when the communication fails to be carried out properly. By contrast, the fourth read-write processing device carries out a fixed number of cycles of communication process independently of the result of communication and lowers the transmission level after each completion of a cycle of communication process. The communication process with the RFID tag may be carried out only once per cycle but, as will be explained below, the communication process may be adapted to be carried out for a plural number of times.

The data creating device, like that of the third read-write processing device, may be adapted to create the safety data based on the cycle of communication process until which communication was carried out properly or the smallest value of the level of the transmission signal when communication was carried out properly and to set the data indicative of this judgment (such as the pass-level and the failure-level) as the data indicative of the margin of communication safety. Alternatively, the ratio or difference may be obtained between the number of cycles in which communication was carried out properly and the total number of cycles and this may be used as the data indicative of the margin of communication safety. Another example may be to multiply the number of cycles in which communication was carried out properly with a specified point number and to use the product thus obtained as indicative of the margin of communication safety. If 5 cycles of communication process are to be carried out, for example, 10 points may be set for each cycle such that the margin of communication safety can be represented by a number where 50 points will be the full score. As further examples, the smallest value of the transmission level when communication was carried out properly or the number of cycles where communication was not carried out properly may be used as the data indicative of the margin of communication safety.

With the third and fourth read-write processing devices, the control device may be preferably adapted to control the adjustment by the level adjusting device such that the transmission level becomes the highest at the first communication process by the communication processing device. If this highest level is used as the aforementioned ordinary level, a sufficient margin of communication safety can be secured.

A fifth read-write processing device according to this invention is characterized as comprising not only a communication processing device, a data creating device and an output device as described above but also a gain adjusting device that adjusts the amplification of a received signal from the RFID tag, a control device that controls operations of the communication processing device while adjusting the amplification of the received signal by using the gain adjusting device, and a judging device that judges whether or not communication with the RFID tag can be carried out properly based upon results of processing by the communication processing device. The control device causes the communication processing device to start communication with the RFID tag under a condition where the amplification is set at a certain value and thereafter changes the amplification to a lower value than the current value while causing the communication to be repeatedly executed as the judging device judges that communication can be carried out properly. The data creating device creates the safety data based on the amplification of the received signal at the point in time when the judging device judges that communication cannot be carried out properly or the number of times the amplification has been changed up to this point in time.

In short, the fifth read-write processing device changes the amplification of the received signal, unlike the third read-write processing device that adjusts the level of the transmission signal. The gain adjusting device may be incorporated into the antenna part as a means for switching the resistance of the return route of an operational amplifier in the receiver circuit. The control and judging devices, like those of the third read-write processing device, may be set by incorporating a necessary program in the control part. The data creating device may be structured like that of the third or fourth read-write processing device.

If the distance between the RFID tag and the antenna part is constant and if the level of the transmission signal is also constant, the possibility of being able to demodulate the signal from the RFID tag may be considered to become lower and that of failing in the communication process may be considered to become higher as the amplification of the received signal becomes smaller. Thus, if the amplification set for an ordinary read-write process (hereinafter referred to as the ordinary amplification) is set as the initial value and a communication process is carried out by reducing the amplification in a stepwise fashion, the margin of communication safety may be regarded as becoming larger as the difference between the amplification at the point in time when the communication process fails and the ordinary amplification becomes larger.

With all of the five read-write processing devices described above, a communication process can be repeated while the amplification of the received signal is made smaller in a stepwise fashion from a specified initial value. The amplification may be reduced at a constant ratio or by a fixed amount but the invention is not limited by this requirement. There may be some fluctuations in the amount of change in the amplification. This statement applies also to the sixth read-write processing device to be described below.

The judging device may be adapted to judge that communication can be carried out properly or not, depending upon whether or not a correct response is obtained to a command. The data creating device, like that for the third read-write processing device, may be adapted to determine the margin of communication safety by dividing it into at least two levels, say, the pass-level and the failure-level, treating the selected level as the data indicative of the margin of communication safety. In this case, the amplification as of the time when it is judged that communication cannot be carried out properly may be compared with a specified threshold value such that it may be concluded that it is the pass-level if the amplification is below the threshold value and that it is the failure-level if the amplification is above the threshold value.

With the fifth read-write processing device, too, the margin of communication safety may be determined by counting the number of times the amplification of the received signal has been changed and comparing the counted value when communication failed with a specified threshold value. Either the pass-level or the failure-level may be treated as the data indicative of the margin of communication safety. Alternatively, the product obtained by multiplying this number of times the amplification has been changed by a specified point number may be set as the data indicative of the margin of communication safety.

A sixth read-write processing device according to this invention is characterized as comprising not only a communication processing device, a data creating device and an output device as described above but also a gain adjusting device that adjusts the amplification of a received signal from the RFID tag and a control device that controls operations of the communication processing device while adjusting the amplification of the received signal by using the gain adjusting device. The control device of this sixth read-write processing device is adapted to cause the communication processing device to execute a communication process with two or more specified number of cycles and to change the amplification to a lower value than the current value every time one cycle of the communication process is finished. The data creating device is adapted to create the safety data based on the cycle of communication process until which communication was carried out properly or the smallest value of the amplification when communication was carried out properly.

The gain adjusting device of the sixth read-write processing device is similar to that of the fifth read-write processing device. The judging device, the control device and the data creating device may be operated similarly to those of the fourth read-write processing device except that the step of adjusting the level of the transmission signal is replaced by that of changing the amplitude. Thus, the sixth read-write processing device creates data indicative of the margin of communication safety by determining the cycle of the communication process until which communication could be carried out properly.

The fifth and sixth read-write processing devices can control the gain adjusting device such that the amplitude will be at the maximum value when the communication processing device carries out the communication process for the first time. If this maximum amplification is used as the ordinary amplification, a sufficient margin of communication safety can be secured at the time of real read-write processing.

The third and fifth read-write processing devices of this invention may be operated such that a communication process is carried out for a specified number of times (twice or more) and the judging device counts the number of times of success or failure. It is judged whether the communication with the RFID tag can be carried out properly or not based on this counted number.

By this mode of operation, a communication process is repeated for a plural number of times while the level of the transmission signal is kept constant in the case of the third read-write processing device and the amplification of the received signal is kept constant in the case of the fifth read-write processing device and it can be determined whether communication can be carried out properly or not based on the number of successes or failures during these plural number of processes. If it is judged that communication can be carried out properly, the control device changes the level of the transmission signal or the amplification and the communication process is further repeated under the changed condition. In this mode of operation, too, as in the case of the second read-write processing device described above, it is desirable to transmit commands of the same content but this is not a requirement. The content of command may be changed at a specified point in time.

The fourth and sixth read-write processing devices of this invention may be operated such that each cycle of communication process carried out by the communication processing device includes a plural number of times of communication process with the RFID tag. The data creating device includes a counting device that counts the number of times of success or failure in each cycle of the communication process and a judging device that judges whether the communication of each cycle has been carried out properly or not on the basis of the counted value obtained by the counting device and creates the data indicative of the margin of communication safety by using the result of judgment for each cycle by the judging device. The judging device may be adapted to calculate the ratio or difference between the counted number and the total number of communication processes within each cycle and to judge whether communication in each cycle was carried out properly or not by comparing this difference value with a specified threshold value.

By the operations described above for the third and fifth read-write processing devices and for the fourth and sixth read-write processing devices, it may be judged that communication cannot be carried out properly if the degree of failure in communication is high even where it was possible to receive normal responses from the RFID tag by a plural number of communication processes. In this way, it will be judged that communications cannot be carried out properly at a point in time when the reliability of communication process drops below a certain level. Thus, an adjustment process for carrying out communications stably (such as the adjustment of the positional relationship between the RFID tag and the antenna part) can be carried out at a higher level of accuracy.

A seventh read-write processing device according to this invention may be characterized not only as comprising a communication processing device, a data creating device and an output device as described above but also wherein the communication process carried out by the communication processing device includes a preliminary communication process with the RFID tag. The seventh read-write processing device further comprises a control device that controls the communication processing device so as to repeatedly carry out the preliminary communication process, to shift to the communication process after a success in the preliminary communication process and to repeatedly carry out the communication process for specified number of cycles.

In the preliminary communication process carried out by the communication processing device, processes for transmitting a command for identifying the kind or memory structure of the RFID tag (referred to as the system read) and receiving a response from the tag corresponding to such a command may be carried out. Such a preliminary communication process is carried out repeatedly and when the communication process is successful, a real communication process for transmitting a substantial command to the tag and receiving a response to such a command is repeated for a specified number of cycles.

A maximum number of times to repeat the preliminary communication process may be preliminarily determined such that the communication process can be stopped if there is no successful communication after this maximum number has been reached.

The seventh read-write processing device is particularly useful when communication is made while the RFID tag is in motion. Unless the RFID tag is inside the communication region of the antenna part, no response can be obtained from the tag for a command although the preliminary communication process is carried out and the communication ends in a failure. After the RFID tag enters the communication region and a situation is established where it is possible to respond to a command in the preliminary communication process, the preliminary communication process succeeds and a real communication process is started.

The data creating device can create data indicative of the margin of communication safety based on the communication result in a real communication process. For this purpose, various processes described regarding the first and second read-write processing devices may be applied. If the structure added to the second through sixth read-write processing devices is incorporated, data indicative of the margin of communication safety can be created by a process explained above with reference to these devices.

The data creating device can also judge the margin of communication safety by using the result of communication in the preliminary communication process. If the margin of communication safety is small although the RFID tag is inside the communication region, the number of times of the preliminary communication process increases as the success ratio of communication becomes low due to the generation of noise, and the timing for shifting to the real communication process may be delayed. If the timing of the tag coming into the communication region can be predicted from its speed of motion or if the arrival of the tag to the communication region can be detected by a sensor or the like, the preliminary communication process can be started based on this predicted or detected timing and the margin of communication safety can be judged based on the number of times of carrying out or the success ratio of the preliminary communication process.

When communication is carried out while the tag is in motion, the margin of communication safety varies not only due to the distance between the tag and the antenna part but also on the speed of motion of the tag or the volume of the transmitted data. If the margin of communication safety is not sufficient, an adjustment may be made by selecting one of any of the factors considered above.

All of the (first through seventh) read-write processing devices described above may further comprise an accumulating device for accumulating the safety data created by the data creating device. In this case, the output device is set to display or output at least either of the safety data immediately after created by the data creating device and the safety data accumulated by the accumulating device. Such an accumulating device may comprise a non-volatile memory and means for storing in this memory data indicative of the margin of communication safety. The latter may be set by incorporating a program in the computer which comprises the aforementioned control part.

By this invention, the read-write processing device for an RFID tag is provided with the function of displaying or outputting data indicative of the margin of safety in a communication process. Thus, when the distance between the RFID tag and the antenna part or the speed of motion of the RFID tag is adjusted, the adjustment can be carried out on the basis of such display or output such that the margin of communication safety can be large. Thus, even in situations where the change in noise level is large, a communication process with an RFID tag can be carried out in a stable manner.

### BRIEF DESCRIPTION OF THE DRAWINGS

FIG. 1 is a block diagram showing the structure of a reader-writer of this invention and a RFID tag with which it carries out communications.

FIG. 2 is a timing chart for the signals related to the transmission and reception by the reader-writer.

FIG. 3 is a timing chart for showing the flow of communication processes among the reader-writer, the tag and a host apparatus.

FIG. 4 is a flowchart for showing an example of processing routine in a test mode.

FIG. 5 is a circuit diagram of an example of transmission level adjusting circuit.

FIG. 6 shows schematically an outline of a method of adjusting distance by adjusting the transmission level.

FIG. 7 is a flowchart for showing the processing routine for the test mode when the method shown in FIG. 6 is employed.

FIG. 8 is a circuit diagram of an example of amplification adjusting circuit.

FIG. 9 is a flowchart for showing another example of processing routine in a test mode.

FIG. 10 is a drawing for showing a condition before a tag in motion enters the communication region of a reader-writer.

FIG. 11 is a drawing for showing a condition where the tag of FIG. 10 has entered the communication region of the reader-writer.

FIG. 12 is a flowchart for showing the processing routine for a test mode when communication is carried out while the tag is in motion.

FIG. 13 is a diagonal external view of a controller separated from the antenna part.

### DETAILED DESCRIPTION OF THE INVENTION

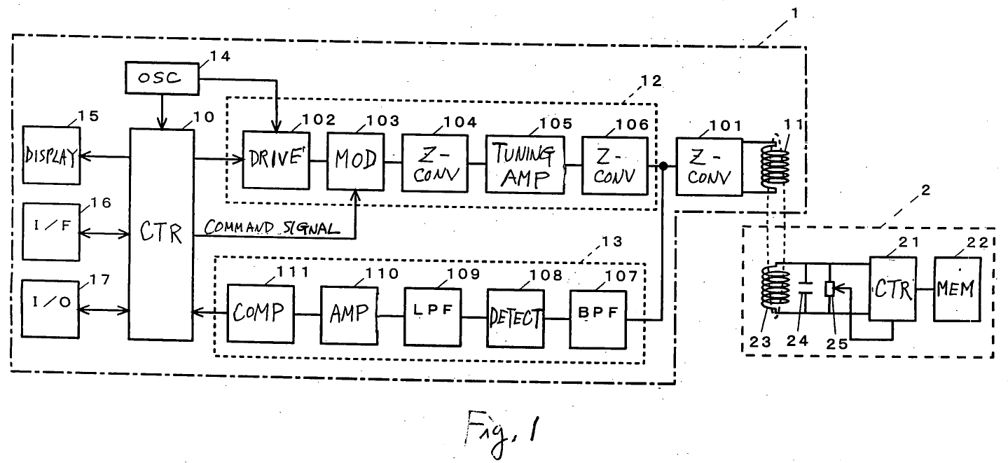

FIG. 1 is a block diagram showing the structure of a reader-writer 1 embodying this invention and a RFID tag (hereinafter referred to simply as a tag) 2 as its object of communication. The tag 2 in this example does not contain a power source, being of the type that operates by an induced electromotive force generated by transmitted waves from the reader-writer 1, and is provided with a control part 21 and a semiconductor memory 22. The tag 2 also comprises an antenna coil 23, a capacitor 24 and a load switch 25 (a resistor With a contact point, according to this example) for communication. The control part 21 of this tag 2 includes not only a computer but also peripheral circuits such as a demodulation circuit for demodulating transmitted signals from the reader-writer 1.

The reader-writer 1 is formed with a control part 10, an antenna coil 11, a transmitter circuit 12, a receiver circuit 13, an oscillator circuit 14 and a Z conversion circuit 101 for a matching process on the antenna coil 11 placed inside a housing structure (not shown). This housing structure is further provided with a display part 15, an interface (I/F) circuit 16 and an input-output (I/O) circuit 17.

The control part 10 on the reader-writer 1 is a computer and carries out communication processing with the tag 2 and test mode processing to be explained below according to a program stored in an internal memory. This control part 10 is also adapted to output high-frequency pulses based on pulse signals from the oscillator circuit 14. The high-frequency pulses become the basis of a carrier wave. When communicating with the tag 2, the control part 10 also serves to output, as a pulse signal, data that represent the content of a command. This output pulse signal is also referred to as a command signal.

The transmitter circuit 12, referred to above, includes a driver circuit 102, a modulator circuit 103, a tuning-amplifying circuit 105 and a pair of Z conversion circuits 104 and 106 sandwiching this tuning-amplifying circuit 105. The receiver circuit 13 includes a bandpass filter (BPF) circuit 107, a detection circuit 108, a low pass filter (LPF) circuit 109, an amplifier circuit 110 and a comparator circuit 111.

The aforementioned display part 15 comprises a numerical displayer for displaying the success ratio of communication (to be explained below) and a plurality of display lights (not shown) and may be at an appropriate position on the housing structure. The interface circuit 16 is used for communication with host apparatus (not shown) such as personal computers and PLCs. The input-output circuit 17 is used for taking in external signals and outputting results of processing.

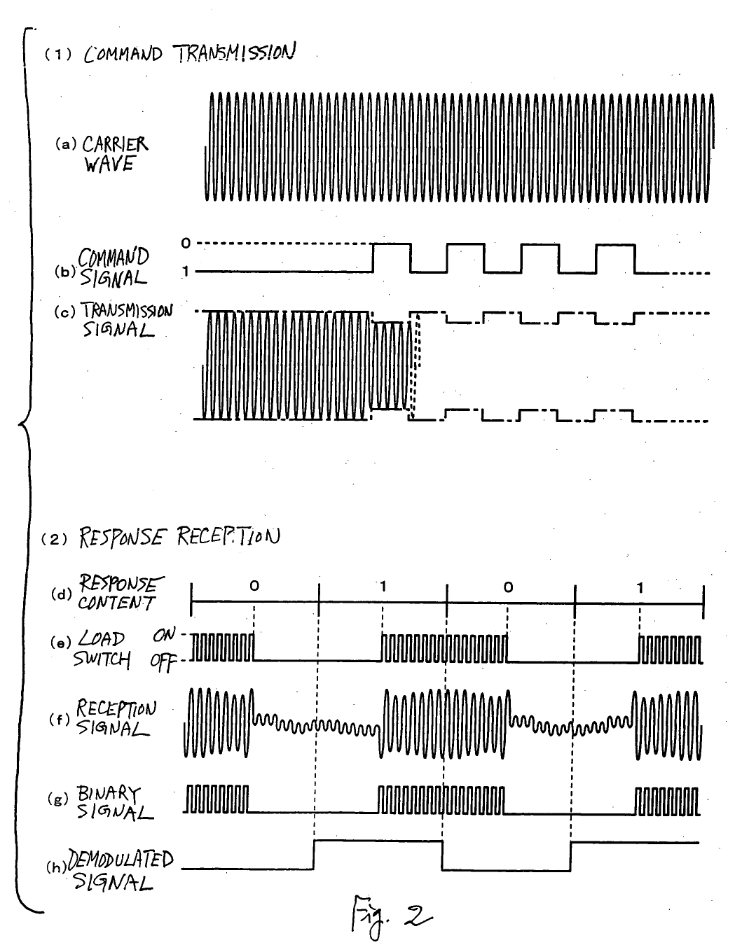

FIG. 2 is a timing chart for the signals related to the transmission and reception by the reader-writer 1 described above. FIG. 2(1) shows the signals related to the command transmission to the tag 2 and FIG. 2(2) shows the signals related to the reception of a response.

In FIG. 2(1), (a) shows the aforementioned carrier wave and (b) shows a command signal which is a pulse width modulated signal of data of each bit comprising a command with “1” showing the low level and “0” showing the high level.

The modulator circuit 103 uses the command signal to modulate (ASK modulation) the carrier wave to generate a transmission signal (c). This transmission signal is provided to the antenna coil 11 after undergoing an amplification process by the tuning-amplifying circuit 105 and an impedance matching process by the Z conversion circuits 104, 106 and 101 and transmitted to the tag 2 as electromagnetic waves.

As the control part 21 of the tag 2 demodulates the transmission signal from the reader-writer 1 and recognizes the contents of the command, it carries out a process corresponding to this command and generates a response that shows the results of this process. In order to return this response, the control part 21 switches the load switch 25 on and off on the basis of the data arrangement as shown in (d) and (e) of FIG. 2(2). In this example, the length of time for transmitting a bit of signal is set equal to the time necessary to repeat the switching on and off of the load switch 25 sixteen times. If the data item to be transmitted is “0”, the load switch 25 is switched on and off eight times during the first half of the aforementioned length of time and the load switch 25 remains switched off during the second half. If the data item to be transmitted is “11”, on the other hand, the load switch 25 is kept switched off during the first half and the load switch 25 is switched on and off eight timed during the second half of the period.

When the reader-writer 1 and the tag 2 are in a relationship where communication is possible, their antenna coils 11 and 23 are in an electromagnetically coupled condition. Thus, as the impedance of the tag 2 is periodically changed by the switching of the load switch 25 on and off, the impedance of the reader-writer 1 also changes accordingly, causing also the current that flows through its antenna coil 11. The receiver circuit 13 serves to detect from this change a signal that represents the aforementioned response, eliminating noise by means of the bandpass filter circuit 107 and thereafter extracting by means of the detection circuit 108 the carrier wave that has been affected by the aforementioned changes in impedance. After the frequency components of the carrier wave are further eliminated by means of the low pass filter circuit 109, an amplification process is carried out by means of the amplifier circuit 110 such that a reception signal (f) as shown in FIG. 2 is detected.

During the period when the load switch 25 is switched on and off, waves with amplitudes greater than a specified value appear in the aforementioned reception signal in synchronism with this switching. Even while the load switch 25 is in the switched-off condition, however, waves with amplitude greater than the specified value may appear due to the influence of noises in the environment. The comparator circuit 111 compares the reception signal with a specified reference level and generates a binary signal (g) as shown in FIG. 2 by extracting waves with large amplitudes. The control part 10 partitions this binary signal (g) in units of bits and thereby obtains a demodulated signal (h), demodulating the data of the individual bits.

The reader-writer 1 starts a communication with the tag 2 as it receives a command (such as a read command or a write command) from a host apparatus and provides the tag 2 with a similar command. As the tag 2 carries out a process according to this command and returns a response, the reader-writer 1 transmits this response back to the host apparatus.

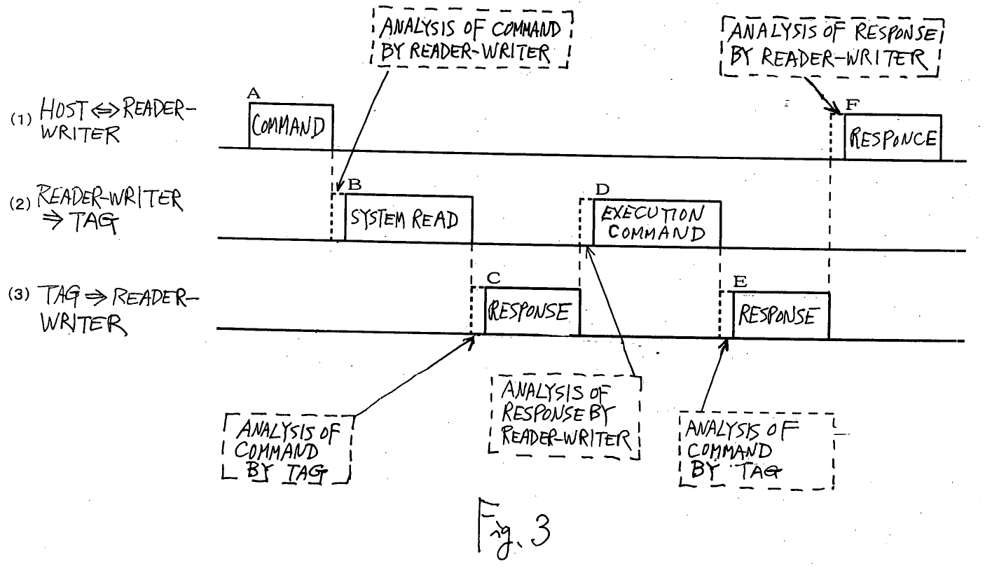

FIG. 3 shows this flow of communications among the reader-writer 1, the tag 2 and a hold apparatus. FIG. 3(1) shows the signals exchanged between the host apparatus and the reader-writer 1, FIG. 3(2) shows the signals transmitted from the reader-writer 1 to the tag 2, and FIG. 3(3) shows the signals transmitted from the tag 2 to the reader-writer 1. In the figure, the portions shown by dotted lines indicate periods during which data are being processed by the reader-writer 1 or the tag 2. Details of these processes are also indicated.

In what follows, the flow of basic data processing for the tag 2 will be explained with reference to reference symbols A, B, etc. of FIG. 3. Firstly, the host apparatus generates a command showing processes to be carried out by the tag 2 and transmits it to the reader-writer 1 (A). After analyzing the content of this command, the reader-writer 1 transmits to the tag 1 a first data readout command (B). In the above, the first data readout is for the purpose of acknowledging the fixed data such as the identification data of the tag 2 and is commonly referred to as the “system read”. After acknowledging and analyzing the system read command, the tag 2 generates a response including specified data and returns it to the reader-writer 1 (C).

The reader-writer 1 analyzes the content of this response and if it is judged to be a normal response, a second command is transmitted to the tag 2 (D). The purpose of this second command is to provide the tag 2 with the content of the command (A) from the host apparatus and to thereby cause this command to be executed. Thus, this command is hereinafter referred to as the execution command. After, analyzing this execution command and executing the process corresponding to its content, the tag 2 generates a response that indicates the details of the process and returns it to the reader-writer 1 (E). Upon recognizing that the response from the tag 2 is normal, the reader-writer 1 transmits it to the host apparatus (F).

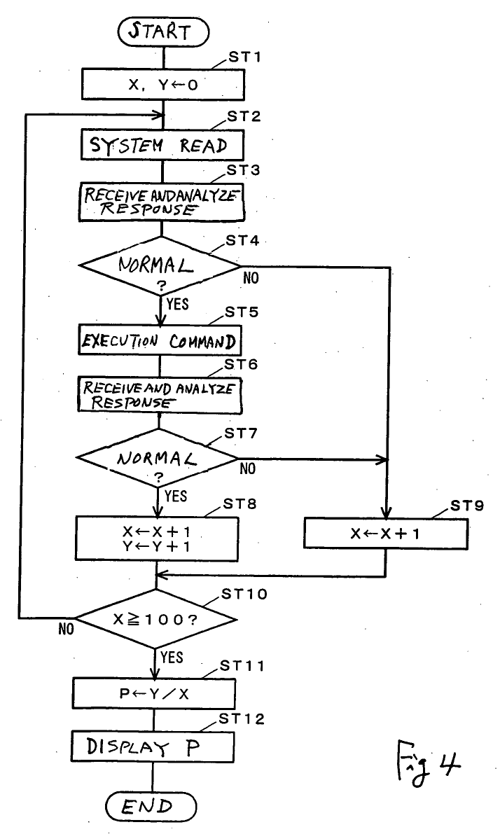

The sequence according to FIG. 3 is intended to be carried out by stopping the tag 2 for a specified length of time in front of the reader-writer 1. In the case of carrying out the communications without stopping the tag 2, the transmission of the system read (B) is repeated until the response (C) is obtained and the transmission of the execution command (D) is thereafter carried out. In the examples shown below with reference to FIGS. 4-9, it will be presumed that the tag 2 is stopped for carrying out communications and hence only one cycle each of the processes of (B) and (C) is carried out.

The reader-writer 1 and the tag 2 of a general RFID system execute the signal exchanges of (B)-(F) for plural numbers of times for a command from a host apparatus. Thus, the host apparatus can accomplish a desired data processing if a normal response can be obtained from the tag 2 in one of these communication processes.

If the safety margin for the communications by the reader-writer 1 and the tag 2 is small, however, the difference between the signal that indicates the desired data and noise is small. In such a situation, if the noise level changes significantly due to a sudden occurrence of noise, for example, the tag 2 or the reader-writer 1 may fail to distinguish between desired data and noise and there is eventually a possibility that no correct response can be obtained from the tag 2.

In view of this possibility, the reader-writer 1 in the following example is adapted to carry out a test mode for checking the safety margin of communications. In this test mode, a test communication is carried out with the tag 2 and a success ratio of communications is obtained and displayed on the display part 15. Since the user is thereby enabled to adjust the distance between the reader-writer 1 and the tag 2 such that communications will be carried out under a condition with a sufficiently high success ratio, the communication safety margin can be maintained sufficiently large and the problem of noise variations can be adequately dealt with.

Next, the flowchart of FIG. 4 is referenced to explain the details of processing in this test mode. In this example, the signal exchanges B-F of FIG. 3 are treated as one time (cycle) of communication and this is carried out 100 times. In this flowchart, X indicates the number of times the communication process is carried out (hereinafter referred to as the execution frequency), Y indicates the number of times of successful communication (hereinafter referred to as the success frequency), and P indicates the communication success ratio.

The processing according to this flowchart, like that of the normal read-write processing shown by FIG. 3, starts by a command from a host apparatus, except that the command is for the start of execution of the test mode. After the variables X and Y are reset to zero (Step ST 1), the aforementioned system read is executed (Step ST2) and then a response from the tag 2 is analyzed while it is being received (Step ST3). If this response is judged to be normal (YES in Step ST4), the aforementioned execution command is transmitted (Step ST5). As a response to this execution command is received, its content is analyzed (Step ST6) and if this response is judged to be normal (YES in Step ST7), the values of X and Y are incremented (Step ST8).

If the response to the system read or the execution command is not judged to be normal (NO in Step ST4 or ST7), the value of X is incremented but not that of Y (Step ST9). If the response to the system read was not obtained normally (NO in Step ST4), Step ST9 alone is carried out and the execution command is not transmitted.

After either Step ST8 or ST9 has been carried out, the program returns to Step ST2 through Step ST10, repeating the steps thereafter and the success frequency Y is incremented after each successful completion of communication. After 100 times of communication have been completed (YES in Step ST10), the value of the communication success ratio P=Y/X is obtained (Step ST11) and is displayed on the display part 15 (Step ST12).

Thus, the user sets a distance tentatively between the reader-writer 1 and the tag 2 and carries out the test mode and if the communication success ratio P is greater than a specified reference value, it may be concluded that a sufficiently large safety margin has been obtained and the tentatively set distance may be used in real operations.

Although the ratio P between the success frequency Y and the execution frequency X was used in the example above, their difference (X-Y) may be considered instead. In this case, the safety margin is considered to be larger as the difference X-Y becomes smaller.

As still another alternative, the ratio of failed communication may be considered. The display of the obtained communication success ratio P need not be made by the reader-writer 1. Instead, the obtained communication success ratio P may be outputted to the host apparatus to have the latter undertake the display process.

The test mode may be carried out by repeating the communication process by reducing the level of the transmission signal to the tag 2 in a stepwise fashion and judging the communication safety margin according to the level of the transmission signal at the moment when the communication process failed. For carrying out a test mode of this kind, a transmission level adjusting circuit 120 as shown in FIG. 5 may be provided to the reader-writer 1, having three resistors R1, R2 and R3 connected in parallel and inserted between the antenna coil 11 and the ground. Each of the resistors R1, R2 and R3 is connected to a switch SW1, SW2 or SW3, respectively such that the overall resistance can be varied, depending on which of the switches SW1, SW2 and SW3 is (or are) switched on. Each of the switches SW1, SW2 and SW3 is switched on and off by the control part 10. Although simple switches SW1, SW2 and SW3 are illustrated in FIG. 5 in simplified manners, it is preferable to form them by means of transistors or analog switches.

The Q value of the antenna coil 11 becomes lower as the resistance of the level adjusting circuit 120 is made larger, and the transmission level becomes lower as the Q value becomes smaller. Thus, the control part 10 in this example carries out a communication process by varying the combination of the switched-on circuits such that the overall resistance of the level adjusting circuit 120 will become larger in a stepwise fashion.

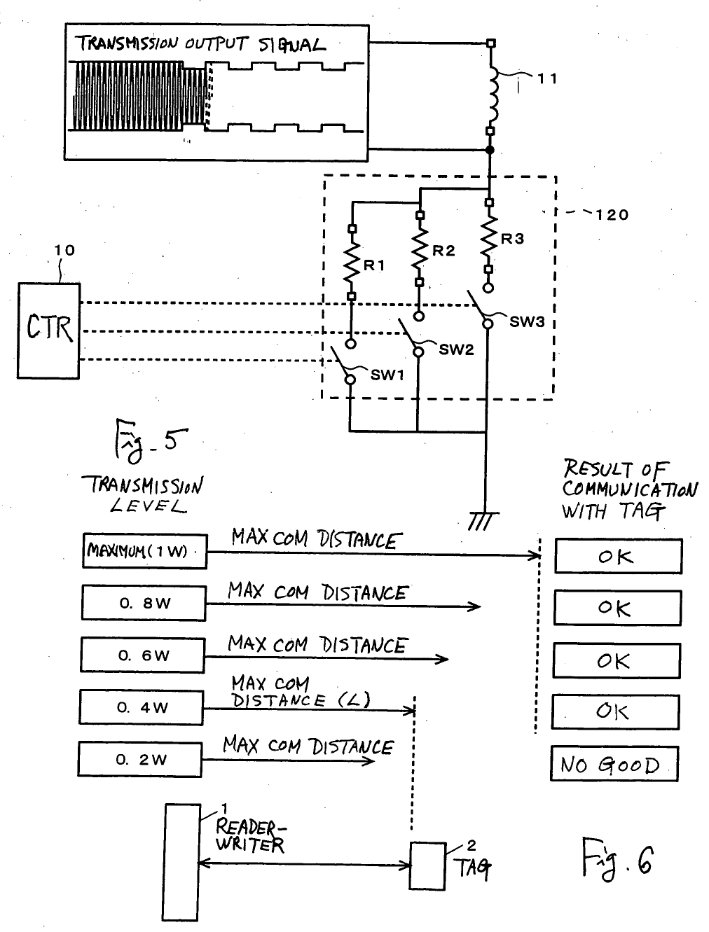

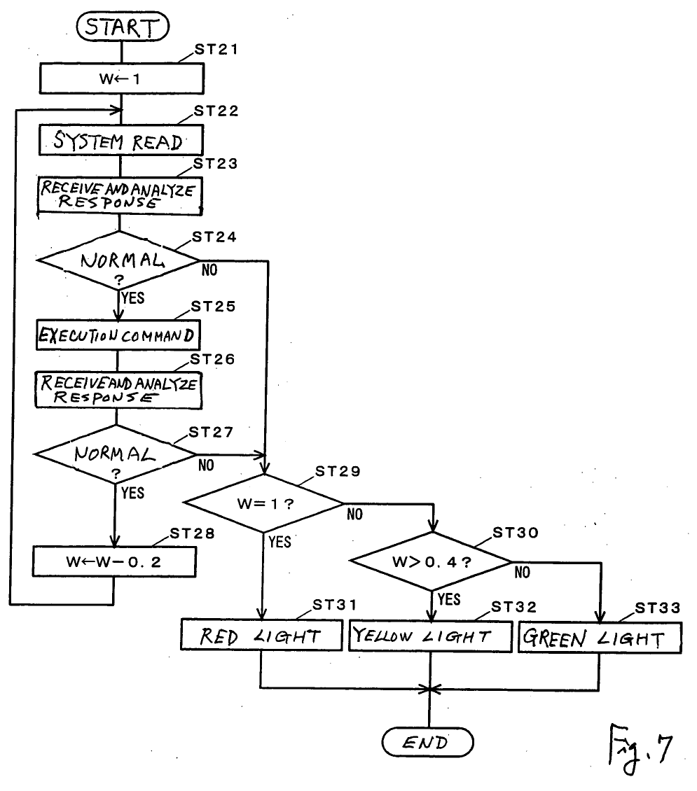

FIG. 6 shows schematically an outline of a method of adjusting the distance between the reader-writer 1 and the tag 2 by adjusting the transmission level. Both for FIG. 6 and for FIG. 7 which follows, it will be assumed for simplifying the explanation that a maximum power output of 1 W can be generated and that power can be reduced in steps of 0.2 W by switching the resistors.

The maximum distance within which a communication is possible with the tag 2 (hereinafter referred to as the maximum communication (MAX COM) distance) is determined, depending upon whether or not power necessary for the tag 2 can be induced by the transmitted waves. Thus, the maximum communication distance becomes smaller if the transmission level becomes lower. If communication is possible unless the transmission level is reduced below 0.4 W, as in the example shown in FIG. 6, it may be considered that the safety margin of communication is sufficient if the transmission level is set to the maximum value of 1 W and the distance between the reader-writer 1 and the tag 2 does not exceed the value L of the maximum communication distance when the transmission level is 0.4 W. Since the maximum communication distance varies according to the level of the environmental noise, it is necessary to ascertain in the test mode.

According to this example of the invention, three display lights with three different colors (red, yellow and green) are used in the test mode to display whether the communication process is totally impossible (red light), communication is possible but a sufficient safety margin cannot be secured (yellow light), or communication is possible with a sufficient margin of safety (green light). The user can easily judge whether the current communication is being carried out with a sufficient margin of safety or not merely by checking which of the displays is being made.

FIG. 7 shows the process routine at the time of test mode. In this flowchart, symbol W indicates the power of the transmission signal expressed in units of watts. This routine also starts, like the routine shown in FIG. 4, by a command from a host apparatus, and the aforementioned transmission level is set at its maximum value of 1 (Step ST21). Next, the system read is carried out (Step ST22) and a response from the tag 2 is received to have its content analyzed (Step ST23). If this response is judged to be normal (YES in Step ST24), the execution command is transmitted (Step ST25). Next, the response to this execution command is received and its content is analyzed (Step ST26). If this response is also normal (YES in Step ST27), the transmission level is reduced by 0.2 W (Step ST28).

The processes of Steps ST22-ST27 are repeated thereafter. Every time the responses to a system read and an execution command are both received successfully, it is considered a success in communication and the transmission level is reduced.

If the response to either the system read or the execution command is not received normally in the loop of Steps ST22-ST28 (NO in Step ST24 or ST27), the routine leaves this loop and checks the transmission level at that moment. If the transmission level has the initial value of 1 (YES in Step ST29), the red display light is switched on (Step ST31). indicating that communication is not possible. If the transmission level is below 1 but above 0.4 (YES in Step ST30), the yellow display light is switched on (Step ST32), indicating that communication is unstable. If the transmission level is not above 0.4 (NO in Step ST30), the green display light is switched on (Step ST33), indicating that communication is possible and stable.

Thus, the user can tentatively set the distance between the reader-writer 1 and the tag 2, carry out the test mode and determine an actual distance according to the test distance at which the green display light is switched on. Since the maximum value (1 in this example) is always set under normal situations, communications can be carried out with a sufficient safety margin.

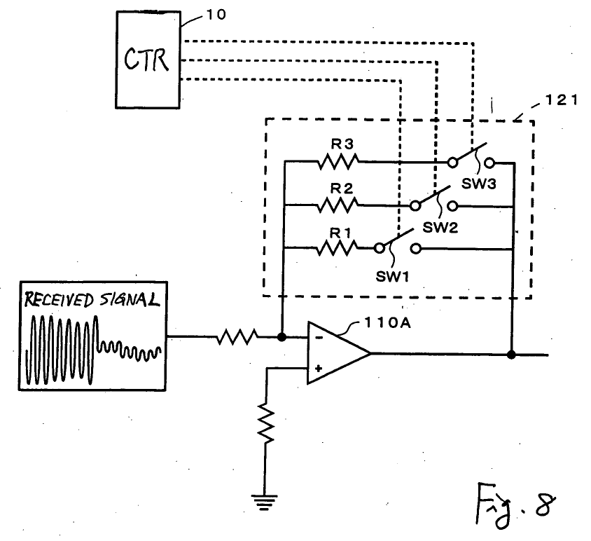

In the example described above, communication processes were carried out while the transmission level was changed. Instead, however, it may be the amplification of the reception signal that is changed. FIG. 8 shows an example where the aforementioned amplifier circuit 110 is provided with the function of varying its amplification, comprising an operational amplifier 110A having an amplification adjusting circuit 121 in its return route. This adjusting circuit 121, like the transmission level adjusting circuit 120 shown in FIG. 5, also comprises three resistors R1, R2 and R3 connected in parallel and three switch circuits SW1, SW2 and SW3 each corresponding to one of the resistors R1, R2 and R3 and adapted to be switched on and off by the control part 10.

In the test mode of this example, the control part 10 sets the amplification at its maximum value to carry out a communication process and if the communication is successful, the amplification is reduced by a specified amount. Thereafter, a routine like that shown in FIG. 7 is followed to reduce the amplification in a stepwise fashion to repeat the communication process and the amplification at the moment when the communication fails is checked. If this amplification is the same as the initial value, a display is made to indicate that communication is not possible. If it is lower than the initial value but is higher than a specified threshold value, the display is made to indicate that communication is unstable. If it is not higher than this threshold value, the display is made to indicate that there is a sufficiently large margin of safety.

As shown in FIG. 2, the level of the reception signal (f) detected by the receiver circuit 13 keeps changing by reflecting noise even while no data are being transmitted from the tag 2 (that is, while the load switch 25 is kept in the switched-off condition). If the amplification is set sufficiently high, this noise level and the original data can be separated. As the amplification is reduced, it becomes harder to separate them. If communication is possible until the amplification is reduced to a value about equal to the aforementioned threshold value, however, it may be concluded that there is a sufficiently large communication safety margin against noise. The user carries out the aforementioned test mode while adjusting the distance between the reader-writer 1 and the tag 2, obtains a distance when the green display light is switched on and set this distance as the adequately safe distance. In this example, too, since the amplification is normally set at the maximum value, communications can be carried out stably.

When a communication process is carried out while the transmission level or the amplification is varied as in the examples explained above, the number of times such changes are made may be counted and the display by the display lights may be controlled by the counted number when the communication fails. For example, the green display light may be switched on if the counted number is zero, the yellow display light may be switched on if the counted number is larger than zero but smaller than a specified threshold number and the green display light may be switched on if the counted number is not smaller than the threshold number.

FIG. 9 shows still another example which is a combination of the routines described above with reference to FIGS. 4 and 7. After the transmission level is set at the maximum value of 1 W (Step ST41), processes similar to those in Steps ST1-ST10 of FIG. 5 (that is, 100 times of communication processes) are carried out (Steps ST42-ST51). Thereafter, the communication success ratio P as defined above is obtained (Step ST52) and if it is equal to or greater than a specified value (=0.98 in the illustrated example) (YES in Step ST53), the transmission level is reduced by 0.2 (Step ST54).

The routine then returns to Step ST42 and similar communication processes are repeated 100 times, each time at a different transmission level and each time by concluding that communication was successful if P is equal to or greater than 0.98.

If the success ratio P becomes smaller than 0.98 (NO in Step ST53) at some point in time, the control part 10 makes an appropriate display according to the transmission level at that point in time as done in Steps ST29-ST33 of FIG. 7 (Steps ST55-ST59). In an example where the amplification of the reception signal is varied instead of the transmission, a control similar to that shown in FIG. 9 can be carried out.

By way of this example, the positional relationship between the reader-writer 1 and the tag 2 can be adjusted more accurately by the method according to FIG. 7 because the margin of communication safety can be checked when the reliability of the communication process becomes below a certain level. Thus, communications can be carried out under an even more stable condition and data processing which is strong against noise can be realized.

Although all of the examples of test mode described above are started as a command from a host apparatus is received, this is not intended to limit the scope of this invention. For example, the reader-writer 1 may be provided with a mode switch such that the test mode can be initiated by itself.

Although all of the examples explained above are arranged such that two commands (one for system read and one execution command) are transmitted in each communication process and a response is received for each of these two commands, furthermore, neither is this intended to limit the scope of the invention. Each communication process may be said to comprise at least one command to be transmitted and reception of a response for each.

Next, another example of test mode will be described for a situation where a margin of communication safety is checked on the assumption that communications are carried out while the tag 2 is in motion.

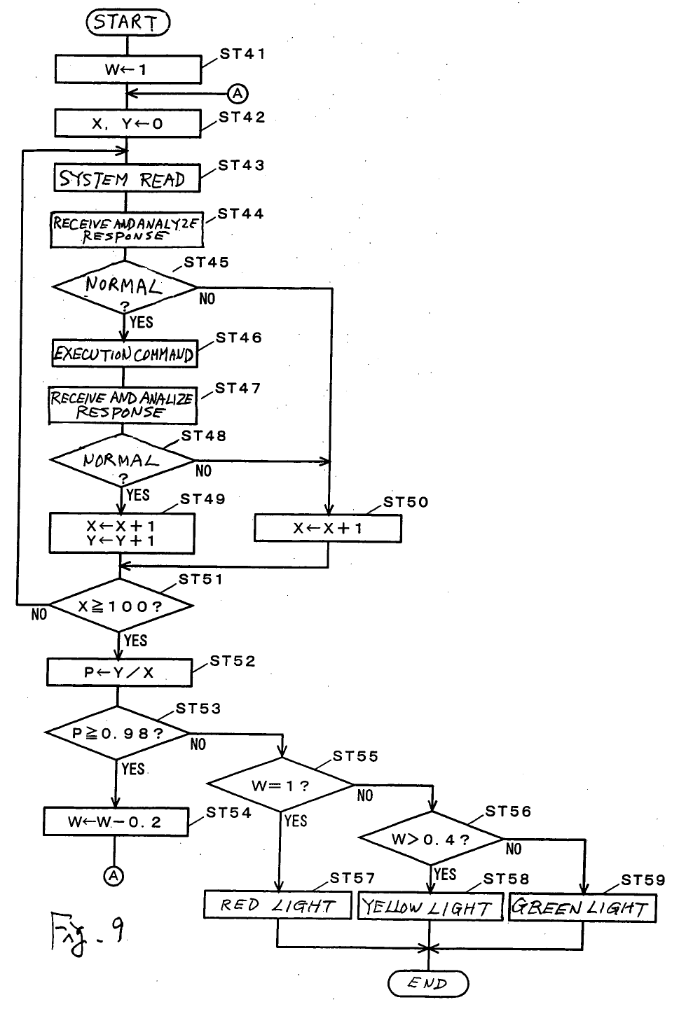

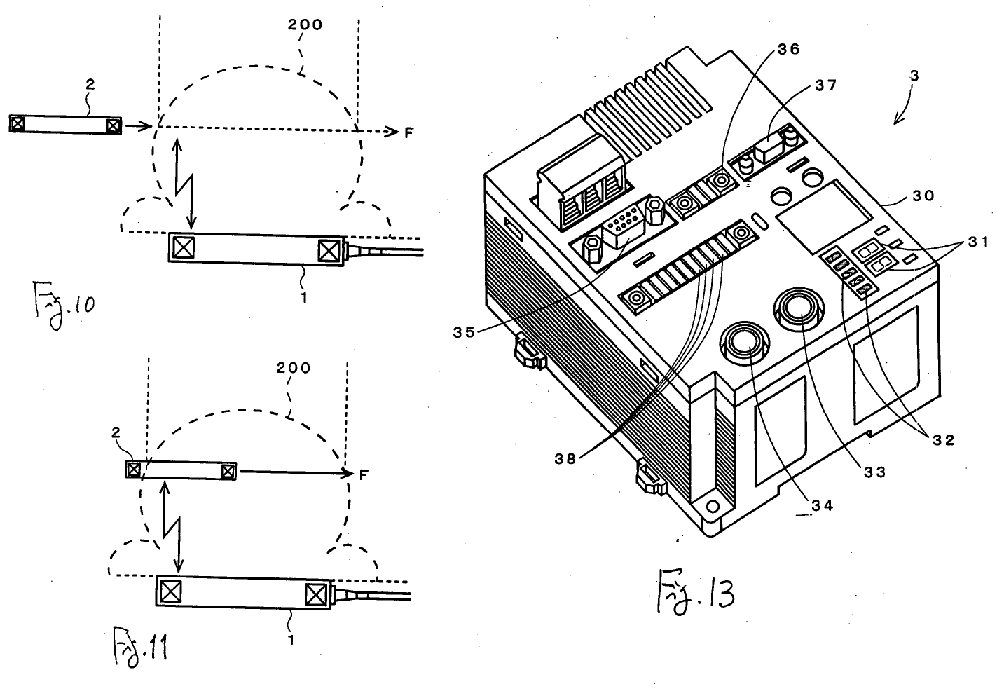

FIG. 10 shows a tag 2 before it enters the communication region 200 of the reader-writer 1 and FIG. 11 shows the tag 2 while it is passing through the communication region 200. At the point in time represented by FIG. 10, no normal response is returned because the tag 2 cannot react to any command that may be transmitted from the reader-writer 1. Once the tag 2 is inside the communication region 200 as shown in FIG. 11, power necessary for communication is induced inside the tag 2 and hence the tag 2 becomes capable of receiving a command from the reader-writer 1. The tag 2 is moving in the direction shown by arrow F but until it departs from the communication region 200, it is possible to exchange commands and responses.

In the case of a test mode with the communication carried out while the tag 2 is in motion, it is necessary to ascertain that the tag 2 has entered the communication region 200 of the reader-writer 1 and hence that communication has become possible. For this reason, according to the present example, the system read (such as shown in FIG. 3 at B) is transmitted repeatedly and the start of the process of transmitting the execution command is conditioned upon a normal response to the system read from the tag 2 (such as shown in FIG. 3 at C).

In the test mode of this example, a dedicated execution command with data volume limited to 1 byte (hereinafter referred to as the test command) is arranged to be transmitted, instead of an ordinary execution command. The test command, like the ordinary execution command, is also for causing the tag 2 to read or write data and a response corresponding to the command is returned from the tag 2.

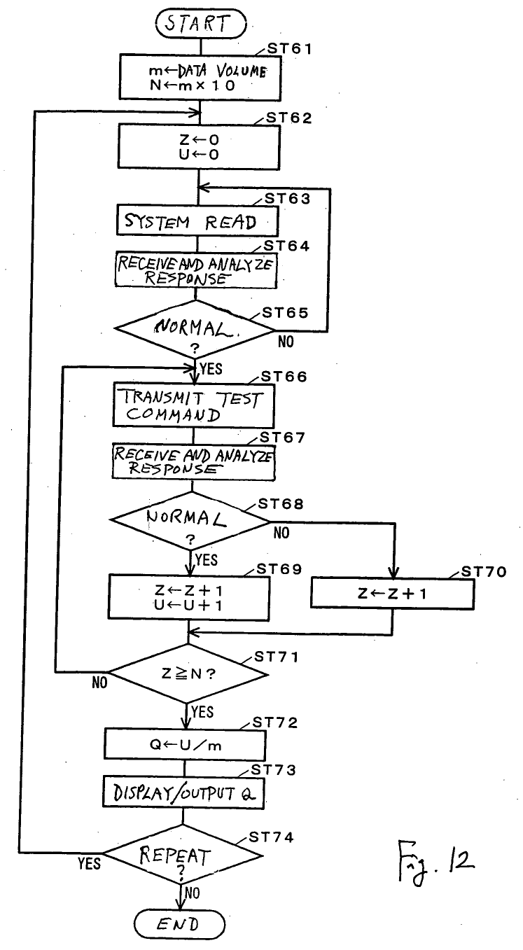

Next, the flowchart of FIG. 12 is referenced to explain in detail the processing routine for this test mode. In this flowchart, symbol Z indicates the communication frequency, or the number of times communication has been executed, symbol U (hereinafter referred to as the success frequency) indicates the number of times a normal response has been received corresponding to a transmitted test command, and symbol Q indicates the margin of communication safety.

Prior to the execution of this routine, the data volume of an ordinary execution command is inputted from a host apparatus to the control part 10. Not only is this data volume initially set as variable m, but this number is also multiplied by a standard transmission frequency (=10 in this example) and this multiplied value is also set as variable N (Step ST61).

Next, after the aforementioned communication frequency Z and success frequency U are reset to zero (Step ST62), the system read is carried out (Step ST63) and its response is received and analyzed (Step ST64). If the response is not acknowledged as a normal response (NO in Step ST65), the routine returns to Step ST63 and the system read is executed again. If a normal response is recognized (YES in Step ST65) after the system read has been executed for any number of times and the routine proceeds to a loop (Steps ST66-ST71) in which the transmission of a test command with 1 byte, the reception of a response to this command and its recognition as done in Steps ST4-ST 10 of FIG. 4 are repeated for N times. Every time a normal response is recognized during these N times of communication, the success frequency U is incremented.

By these steps described above, the system read is executed repeatedly until a normal response is obtained to determine whether or not the tag 2 has entered the communication region and the transmission of the test command may be started. As the test command is transmitted N times, the same amount of data can be transmitted to the tag 2 as if an actual execution command is transmitted for a standard number (=10) of times.

After the loop of Steps ST66-ST71 is executed N times (YES in Step ST71), the success frequency U is divided by the data volume of normal execution command and the result thus obtained is set as the margin of safety Q (Step ST72). The margin of safety Q thus set is displayed and outputted to external apparatus (Step ST73). The routine returns to Step ST62 thereafter if the test is to be repeated on another tag 2 (YES in Step ST74). In other words, a margin of safety Q is obtained for each tag 2.

When communication process is to be carried out while the tag 2 is in motion, it is more difficult to do so for a sufficient number of times than if it is done while the tag 2 is stopped. Especially when the data volume of the execution command is large, the number of times communication can be made becomes smaller. If communication fails due to an effect of noise in such a situation, it may become difficult to carry out a communication process for a necessary number of times.

The success frequency U in the example described above is the number of times a communication by a command with the minimum data unit (=1 byte) was successful. Thus, this may be considered to represent the data volume that can be transmitted to the tag 2 while this tag 2 is passing through the communication region 200. The margin of safety Q calculated in Step ST72 by dividing the success frequency U by the data volume m may be considered to represent the number of times the execution command can be transmitted to the tag 2 (hereinafter referred to as the transmittable frequency). Thus, the user can easily ascertain from the margin of safety Q obtained in the test mode of FIG. 12 whether or not the present condition allows communication process to be carried out for a necessary number of times.

If the user judges that the margin of safety is not adequate, the user may adjust not only the distance between the reader-writer 1 and the tag 2 but also the speed of motion of the tag 2. If possible, the user may also change the data volume of the execution command in order to improve the margin of safety.

The numerical value to be outputted as the margin of safety Q need not be limited to be the transmission frequency of the command but may also be the value of U, that is, the data volume that can be transmitted to the tag 2. The communication success ratio may also be used as explained above with reference to FIG. 4.

All of the examples described above are applicable to the kind of reader-writer 1 having an antenna part and a control part having the functions of read and write integrated but this is not intended to limit the scope of the invention. The present invention is equally applicable to a controller separated from an antenna part. FIG. 13 shows an example of such a controller 3 separated from an antenna part, having a housing structure 30 containing therein the controller part 10, the interface circuit 16 and the input-output circuit 17 of FIG. 1. A plurality of connectors, numerical displayers 31 and display lights 32 are provided on the upper surface of the housing structure 30.

Of the numerous connectors illustrated, connectors 33 and 34 are for connecting to an antenna part (not shown). Connectors 35, 36 and 37 are for connecting to host apparatus such as personal computers and PLCs. Connector 38 is for outputting numerical data related to the margin of communication safety to a host apparatus.

The numerical displayers 31 are used for displaying the numbers for the communication success ratio P and the margin of safety Q. The display lights 32 may be used for displaying these numbers by classifying them into a plurality of step levels or the stability of communication as explained above with reference to FIGS. 7 and 9.

A non-volatile memory may be incorporated in the reader-writer 1 or the controller 3. The margin of safety obtained in a test mode may be accumulated in such a non-volatile memory such that the accumulated data can be outputted to a host apparatus in response to a command therefrom. With such a function, the user can investigate the margin of safety obtained in a test mode executed in the past or its change with time.

The process of reading out such accumulated data need not be carried out in response to a command from a host apparatus. It may be so arranged that whenever a command to carry out a test mode, a response may be created by including data obtained in that test mode as well as data accumulated over a specified past period and be transmitted to the host apparatus.

1. A read-write processing device for communicating with an RFID tag provided with a semiconductor memory to carry out read and write processes with said semiconductor memory; said read-write processing device comprising:
a communication processing device that executes communication processes with said RFID tag;
a data creating device that creates safety data indicative of a margin of safety of communication based on communication results by said communication processing device; and
an output device that displays or outputs to the outside said safety data created by said data creating device.

2. The read-write processing device of claim 1 wherein said data creating device counts the number of times of success or failure in communication while said communication processing device executes a plural number of times of the communication processes and obtains the margin of safety based on the counted number of times.

3. The read-write processing device of claim 1 further comprising:
a level adjusting device that adjusts the transmission level of transmission signal transmitted to said RFID tag;
a control device that controls operations of said communication processing device while adjusting said transmission level by means of said level adjusting device; and
a judging device that judges whether or not communication with said RFID tag can be carried out properly based upon results of processing by said communication processing device;
wherein said control device causes said communication processing device to start communication with said RFID tag under a condition where the level of said transmission signal is set at a certain value and thereafter changes the level of said transmission signal to a lower value than the current value while causing the communication to be repeatedly executed as said judging device judges that communication can be carried out properly; and
wherein said data creating device creates the safety data based on the level of the transmission signal at the point in time when said judging device judges that communication cannot be carried out properly or the number of times the level of the transmission signal has been changed until said point in time.

4. The read-write processing device of claim 1 further comprising:
a level adjusting device that adjusts the transmission level of transmission signal transmitted to said RFID tag; and
a control device that controls operations of said communication processing device while adjusting said transmission level by means of said level adjusting device;
wherein said control device causes said communication processing device to execute a specified plural number of cycles of communication process and changes the level of the transmission signal to a lower value than the current value every time one cycle of said communication process is finished; and
wherein said data creating device creates said safety data based on the cycle of said communication process until which communication was carried out properly or the smallest value of the level of the transmission signal when communication was carried out properly.

5. The read-write processing device of claim 1 further comprising:
a gain adjusting device that adjusts the amplification of a received signal from said RFID tag;
a control device that controls operations of said communication processing device while adjusting the amplification of said received signal by using said gain adjusting device; and
a judging device that judges whether or not communication with said RFID tag can be carried out properly based upon results of processing by said communication processing device;
wherein said control device causes said communication processing device to start communication with said RFID tag under a condition where said amplification is set at a certain value and thereafter changes said amplification to a lower value than the current value while causing the communication to be repeatedly executed as said judging device judges that communication can be carried out properly; and
wherein said data creating device creates the safety data based on the amplification of the received signal at the point in time when said judging device judges that communication cannot be carried out properly or the number of times the amplification has been changed until said point in time.

6. The read-write processing device of claim 1 further comprising:
a gain adjusting device that adjusts the amplification of a received signal from said RFID tag; and
a control device that controls operations of said communication processing device while adjusting the amplification of said received signal by using said gain adjusting device;
wherein said control device causes said communication processing device to execute a specified plural number of cycles of communication process and changes the amplification to a lower value than the current value every time one cycle of said communication process is finished; and
wherein said data creating device creates said safety data based on the cycle of said communication process until which communication was carried out properly or the smallest value of the amplification when communication was carried out properly.

7. The read-write processing device of claim 3 wherein every time said communication processing device carries out a communication process for a specified plural number of times, said judging device counts the number of success or failure in said specified plural number of times of the communication process and judges whether communication with said RFID tag can be carried out properly or not based on the counted number of success or failure.

8. The read-write processing device of claim 5 wherein every time said communication processing device carries out a communication process for a specified plural number of times, said judging device counts the number of success or failure in said specified plural number of times of the communication process and judges whether communication with said RFID tag can be carried out properly or not based on the counted number of success or failure.

9. The read-write processing device of claim 4 wherein the communication process carried out by said communication processing device includes per cycle a plurality of times of communication processes with said RFID tag and wherein said data creating device includes a counting device that counts the number of success or failure in each cycle of the communication process, and a judging device that judges whether the communication of each cycle has been carried out properly or not based on the number counted by said counting device and creates said safety data by using judgment result by said judging device.

10. The read-write processing device of claim 6 wherein the communication process carried out by said communication processing device includes per cycle a plurality of times of communication processes with said RFID tag and wherein said data creating device includes a counting device that counts the number of success or failure in each cycle of the communication process, and a judging device that judges whether the communication of each cycle has been carried out properly or not based on the number counted by said counting device and creates said safety data by using judgment result by said judging device.

11. The read-write processing device of claim 1 wherein the communication process carried out by said communication processing device includes a preliminary communication process with said RFID tag, said read-write processing device further comprising a control device that controls said communication processing device to repeatedly carry out said preliminary communication process, to shift to the communication process after a success in the preliminary communication process and to repeatedly carry out the communication process for specified number of cycles.

12. The read-write processing device of claim 1 further comprising an accumulating device for accumulating the safety data created by said data creating device;
wherein said output device displays or outputs at least either of the safety data immediately after created by said data creating device and the safety data accumulated by said accumulating device.

13. The read-write processing device of claim 2 further comprising an accumulating device for accumulating the safety data created by said data creating device;
wherein said output device displays or outputs at least either of the safety data immediately after created by said data creating device and the safety data accumulated by said accumulating device.

14. The read-write processing device of claim 3 further comprising an accumulating device for accumulating the safety data created by said data creating device;
wherein said output device displays or outputs at least either of the safety data immediately after created by said data creating device and the safety data accumulated by said accumulating device.

15. The read-write processing device of claim 4 further comprising an accumulating device for accumulating the safety data created by said data creating device;
wherein said output device displays or outputs at least either of the safety data immediately after created by said data creating device and the safety data accumulated by said accumulating device.

16. The read-write processing device of claim 5 further comprising an accumulating device for accumulating the safety data created by said data creating device;
wherein said output device displays or outputs at least either of the safety data immediately after created by said data creating device and the safety data accumulated by said accumulating device.

17. The read-write processing device of claim 6 further comprising an accumulating device for accumulating the safety data created by said data creating device;
wherein said output device displays or outputs at least either of the safety data immediately after created by said data creating device and the safety data accumulated by said accumulating device.

18. The read-write processing device of claim 7 further comprising an accumulating device for accumulating the safety data created by said data creating device;
wherein said output device displays or outputs at least either of the safety data immediately after created by said data creating device and the safety data accumulated by said accumulating device.

19. The read-write processing device of claim 8 further comprising an accumulating device for accumulating the safety data created by said data creating device;
wherein said output device displays or outputs at least either of the safety data immediately after created by said data creating device and the safety data accumulated by said accumulating device.

20. The read-write processing device of claim 9 further comprising an accumulating device for accumulating the safety data created by said data creating device;
wherein said output device displays or outputs at least either of the safety data immediately after created by said data creating device and the safety data accumulated by said accumulating device.
